(19) United States
(12) Patent Application Publication
(10) Pub. No.: US 2012/0290968 A1
(43) Pub. Date: Nov. 15, 2012

(54) Web Link Quick Send Add-On For Internet Browsers

(76) Inventor: Christopher Michael Cecora, Manhasset, NY (US)

(21) Appl. No.: 13/107,077

(22) Filed: May 13, 2011

(51) Int. Cl. G06F 3/048

(52) U.S. Cl. 715/780; 715/781

(57) ABSTRACT

An internet browser add-on for sending web links to a friend. The add-on button displays a list of friend contact information graphically that can be selected for sharing a weblink through simple clicking. The add-on button also enables importing contacts from an internet mail server.

### DESCRIPTION OF RELATED ART

1. Field of the Invention

The present application relates to an internet browser toolbar function, and more particularly to an internet browser add-on button that allows quickly sending a web link to a friend or a particular group of receivers. In an embodiment a button is pressed or a key combination is pressed with a mouse click which is either in the user's browser, on the user's desktop or on the user's mobile device, and a window is opened which displays all or the user's friends/contacts. With the mouse button held down, the user can then drag the mouse cursor over to the friend he/she wants to share with, and hovers over the friends image with the mouse cursor for more than a second to select it. To share with more than one person the process is repeated. The mouse button is then released to send the quicklink/email with the link to all of the selected friends.

2. Description of Related Art

Note that the points discussed below may reflect the hindsight gained from the disclosed inventions, and are not necessarily admitted to be prior art.

A web browser's standard “toolbar” is often customarily modified in appearance and function through the addition to the standard browser toolbar customary add-ons, plugins or “hotbuttons.” Numerous add-ons are developed to add more user friendly functions to a standard web browser, such as Microsoft™ Internet Explorer, the open source Firfox browser and Google™ Chrome for internet related uses.

Traditional toolbars includes functions to send web links to an email address by typing in the recipient email address real time. For example, US 2010/0158391 A1 describes a web function that shares web media objects by sending segments of the media objects or web link of the media objects to friends by typing in the friend's email address. However it is cumbersome to input a friend's email address real time to send him/her a web link.

A user friendly add-on button is therefore developed in this application to satisfy the user needs in quickly choosing or identifying a recipient to send a web link.

### SUMMARY OF THE INVENTION

In an exemplary embodiment of the invention there is disclosed emailing or sharing with someone information with one click or one step. A single action. A button for performing the single action may reside within the browser or be in a desktop running Windows, Mac or Linus for the mobile and tablets IOS or Androit. A user clicks on the Quicklink icon which is located inside the browser of, for example, Google Chrome, Mozilla Firefox, Internet Explorer, Apple Safari, or Opera located in the toolbox, and holds the mouse button down.

In an alternative embodiment of activating the browser extension, the user holds down the mouse button anywhere inside the browser window for a specific period of time, for example two seconds, to open the Quicklink browser extension popup window to show all of the user's friends profile pictures to select from.

In an alternative embodiment of activating the browser extension a combination of keys may be depressed while holding down the mouse button. This action opens up the Quicklink browser extension popup window that displays the profile images of all of the user's contacts/friends. With the mouse button still being held down, the user drags the mouse cursor over the profile picture of the friend that he/she would like to share with and will hover over the profile picture with the mouse cursor for a specified time period of, for example, one and one-half seconds, to select the friend. When a friend is selected, the profile picture will become darker and have a border around it to inform the user it is selected. If a user wants to select another friend, then with the mouse button still being held down, he/she will drag the mouse cursor over to another profile picture, and hover with the mouse over the profile picture for one and one-half seconds to select it.

Once all of the friends have been selected, the user releases the mouse button which will automatically send the qucklink.

Stated more briefly, A) a button is pressed or a key combination is pressed with a mouse click which is either in the user's browser, on the user's desktop or on the user's mobile device, and a window is opened which displays all or the user's friends/contacts; B) with the mouse button held down, the user can then drag the mouse cursor over to the friend he/she wants to share with, and hovers over the friends image with the mouse cursor for more than a second to select it. To share with more than one person the process is repeated. And C) The mouse button is released to send the quicklink/email with the link to all of the selected friends.

The present application discloses a user friendly quicklink add-on button/plugin that provides a pop-up window for conveniently choosing friends or a group of correspondents to send a web link to.

In one embodiment, the quicklink add-on button allows importing quick-link friends from an email contact database.

In one embodiment, the quicklink pop-up window allows several display options of quick-link friends, which may list the friends in alphabetic order and with images.

In one embodiment, the quicklink pop-up window, in addition to send a quicklink of a web page, also allows the sender add a note and multiple recipients may be selected to receive the quick web-link simultaneously.

In another aspect of an embodiment, the add-on button and its other interactive buttons may be designed as non-click buttons; placing the cursor over the buttons for a longer than usual time would activate the button functions.

The disclosed innovation, in various embodiments, provides one or more of at least the following advantages. However, not all of these advantages result from every one of the innovations disclosed, and this list of advantages does not limit the various claimed inventions.

The disclosed innovation allows a sender to quickly and graphically select one or more weblink recipients with a few clicks without having to typing and memorizing the recipient's email addresses.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 shows a partial screen-shot of an example internet browser having a quicklink hot button in accordance with this application.

FIG. 2 shows a screen-shot of an example pop-up window of a quicklink hot button in accordance with this application.

FIG. 3 shows a screen-shot of an example quicklink pop-up window at editing status in accordance with this application.

FIG. 4 shows a screen-shot of an example quicklink pop-up window at editing a friend profile in accordance with this application.

FIG. 5 shows a screen-shot of an example quicklink pop-up window at adding a note in accordance with this application.

FIG. 6 shows a screen-shot of an example quicklink pop-up window at creating a friend profile in accordance with this application.

FIG. 7 shows a screen-shot of an example quicklink pop-up window at importing friend profiles from an internet email contact database in accordance with this application.

FIG. 8 shows a screen-shot of an example quicklink pop-up window at selecting multiple recipients simultaneously in accordance with this application.

FIG. 9 shows a screen-shot of an example quicklink pop-up window at logging in user interphase in accordance with this application.

FIG. 10 shows a screen-shot of an example quicklink pop-up window at registering a user in accordance with this application.

FIG. 11 shows a screen-shot of an example quicklink pop-up window when no contact profile is in the database.

FIG. 12 schematically shows an example quicklink pop-up window of an alternative embodiment showing advertisement.

### DETAILED DESCRIPTION OF SAMPLE EMBODIMENTS

The numerous innovative teachings of the present application will be described with particular reference to presently preferred embodiments (by way of example, and not of limitation). The present application describes several embodiments, and none of the statements below should be taken as limiting the claims generally.

For simplicity and clarity of illustration, the drawing figures illustrate the general manner of construction, and description and details of well-known features and techniques may be omitted to avoid unnecessarily obscuring the invention. Additionally, elements in the drawing figures are not necessarily drawn to scale, some areas or elements may be expanded to help improve understanding of embodiments of the invention.

The terms “first,” “second,” “third,” “fourth,” and the like in the description and the claims, if any, may be used for distinguishing between similar elements and not necessarily for describing a particular sequential or chronological order. It is to be understood that the terms so used are interchangeable. Furthermore, the terms “comprise,” “include,” “have,” and any variations thereof, are intended to cover non-exclusive inclusions, such that a process, method, article, apparatus, or composition that comprises a list of elements is not necessarily limited to those elements, but may include other elements not expressly listed or inherent to such process, method, article, apparatus, or composition.

Examples of well known computing systems, environments, and or configurations that may be suitable for use include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

It is contemplated and intended that the disclosed design apply to all and any types of internet web browsers; for clarity reason, the examples only show the design with Google Chrome™.

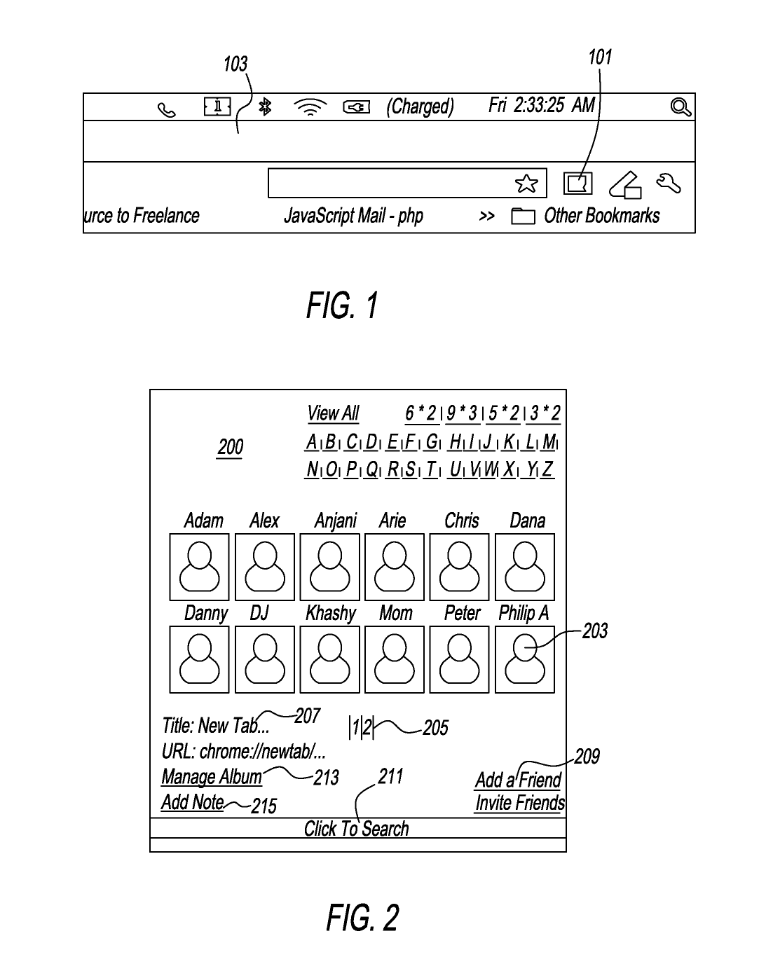

In reference to FIG. 1, it is a screen shot of web browser Safari 103 or Internet Explorer running on Max OS operating system. A Quicklink pop window add-on button 101 is added to the toolbar. The physical apparatus required to enable one embodiment includes a web server; a web portal interface; a multi-user network; and an application server. The application server provides a means for allowing a local user computer to download and install the add-on software module taught by the present application to any Internet browser. The disclosed Quicklink add-on module application may also be recorded onto a CD, or any other recordable medium as well as being delivered electronically from a database to a computer, wherein the method embodied by the software that is recorded is then executed by a computer for use and transformation of the Internet browser and its contents. The application module may include further a Download module to user computer and an Install/Remove module of the add-on software module.

to operate a user clicks on the Quicklink icon and holds the mouse button down. In an alternative embodiment the user holds down the mouse button anywhere inside the browser window for a specific period of time, for example two seconds, to open the Quicklink browser extension popup window to show all of the user's friends profile pictures to select from. In an alternative embodiment, a combination of keys may be depressed while holding down the mouse button. This action opens up the Quicklink browser extension popup window that displays the profile images of all of the user's contacts/friends. With the mouse button still being held down, the user drags the mouse cursor over the profile picture of the friend that he/she would like to share with and hovers over the profile picture with the mouse cursor for a specified time period of, for example, one and one-half seconds, to select the friend. When a friend is selected, the profile picture will become darker and have a border around it to inform the user it is selected. If a user wants to select another friend, then with the mouse button still being held down, he/she will drag the mouse cursor over to another profile picture, and hover with the mouse over the profile picture for one and one-half seconds to select it.

Once all of the friends have been selected, the user releases the mouse button which will automatically send the qucklink.

Stated more briefly, A) a button is pressed or a key combination is pressed with a mouse click which is either in the user's browser, on the user's desktop or on the user's mobile device, and a window is opened which displays all or the user's friends/contacts; B) with the mouse button held down, the user can then drag the mouse cursor over to the friend he/she wants to share with, and hovers over the friends image with the mouse cursor for more than a second to select it. To share with more than one person the process is repeated. And C) The mouse button is released to send the quicklink/email with the link to all of the selected friends.

The present application discloses a user friendly quicklink add-on button/plugin that provides a pop-up window for conveniently choosing friends or a group of correspondents to send a web link to.

Generally, software modules include routines, programs, objects, components, data structures, etc. that perform particular tasks or implement particular abstract data types practiced and known to an ordinary person in the art. The described implementations may also be practiced in distributed computing environments where tasks are performed by remote processing devices that are linked through a communication network. In a distributed computing environment, program modules may be located in both local and remote computer storage media including memory storage devices. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

When a computing device is started and a web browser is activated and stored in the memory that enables the computing device to be used to communicate over a network (not shown) such as the Internet. When the add-on button 101 is clicked or activated by a user, a web page Quicklink toolbar application object is created and stored in the memory and is configured to provide the functionality shown and described in relation to the figures herein. The memory also stores a Quicklink database that stores data associated with the shown and described Quicklink graphical user interface in this application. Such data includes, but is not limited to, stored Friends contact information, web page data, web page metadata, user comments associated with saved web pages, and the like.

The application may create necessary functional objects that are required to perform the functions in relation to the described Quicklink user interface. An example functional object may include properties containing a selected friend's information, a page link to selected or saved web page, page information saved from the web page, and page metadata and other notes or messages. The other objects may include functions to interact with various components of the system and databases. Still other objects may include user interphase or graphical designation information. The interactions between the objects may be determined by the software language chosen to implement the software, and are standard processes that an ordinary person in the art knows how to implement and use.

In reference to FIG. 2, when at an interesting web site which a user want to share with a group of friends, he/she then clicks on the Quicklink button 101 to activate the functions of Quicklink button 101, and a pop up window 200 opens. The window shows a list of contact information of friends populated from contact databases, saved either on a server or locally on the user's computer. The contact information may be listed in alphabetical order shown in 201, and graphically shown in 203 with choices of a number of layouts, such as 6 picture a row for 2 rows, or 9 pictures a row for 3 rows, or 5 pictures a row for 2 rows, etc. The number of available pages is displayed as shown in 205.

By simply clicking on the images of friends in 203, the associated email addresses of these friends are collected for sending the URL and the note to these email addresses.

The other functions on window 200 includes the URL 207 of the interested web page to be sent, the “add note” 215 for creating a note together with the URL to be sent, the “manage album” 213 for updating pictures of the contacts, the “add friend” button 209 for adding new contacts, the “invite friend” button for inviting a contact to communicate, and the “Click to Send” button 211 to send a message to selected recipients.

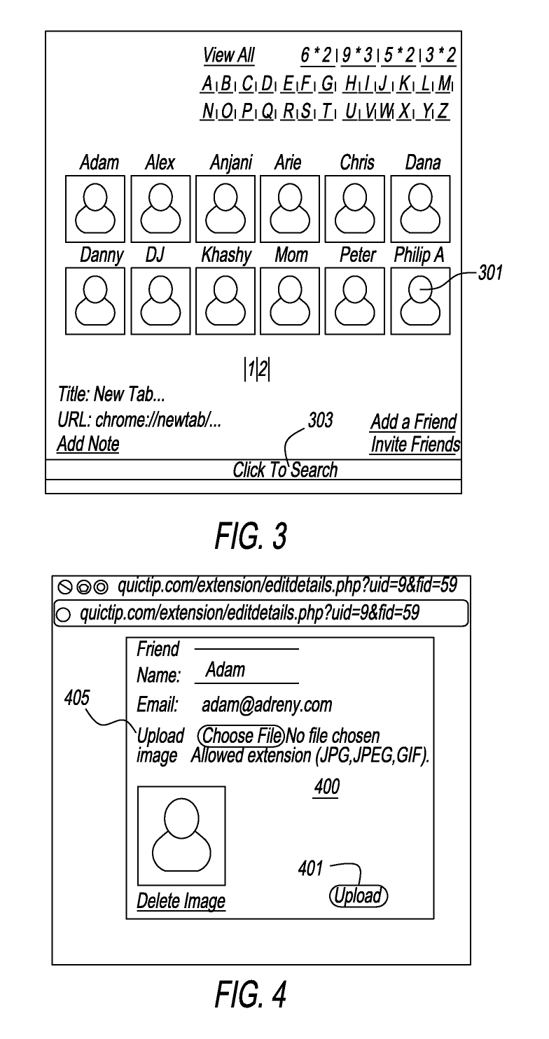

Simply clicking on “managing Album” 213 leads window 200 change to window interface shown in FIG. 3 where each of the contact images 301 and associated profiles are editable. The window has a button 303 to go back to the un-editable window 200.

Simple by clicking an image of 301, the window is activated to window 400 as shown in FIG. 4 for updating the selected contact's profile, which includes functions such as “uploading” the picture 405, or “deleting” the picture 403, and “update” the profile 401 by saving the change to the database.

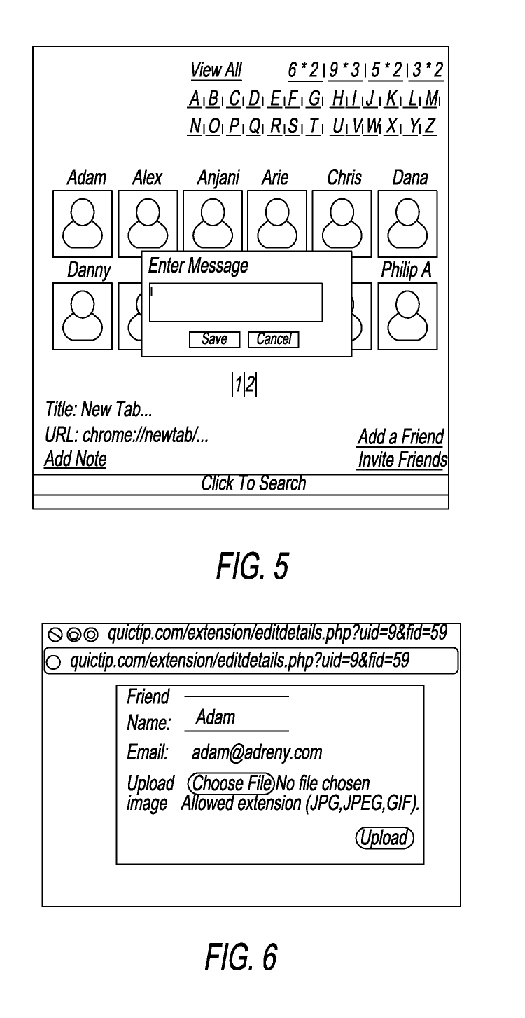

FIG. 5 shows an example pop-up window for “adding a note” button.

FIG. 6 shows an example pop-up window for “adding a friend” button.

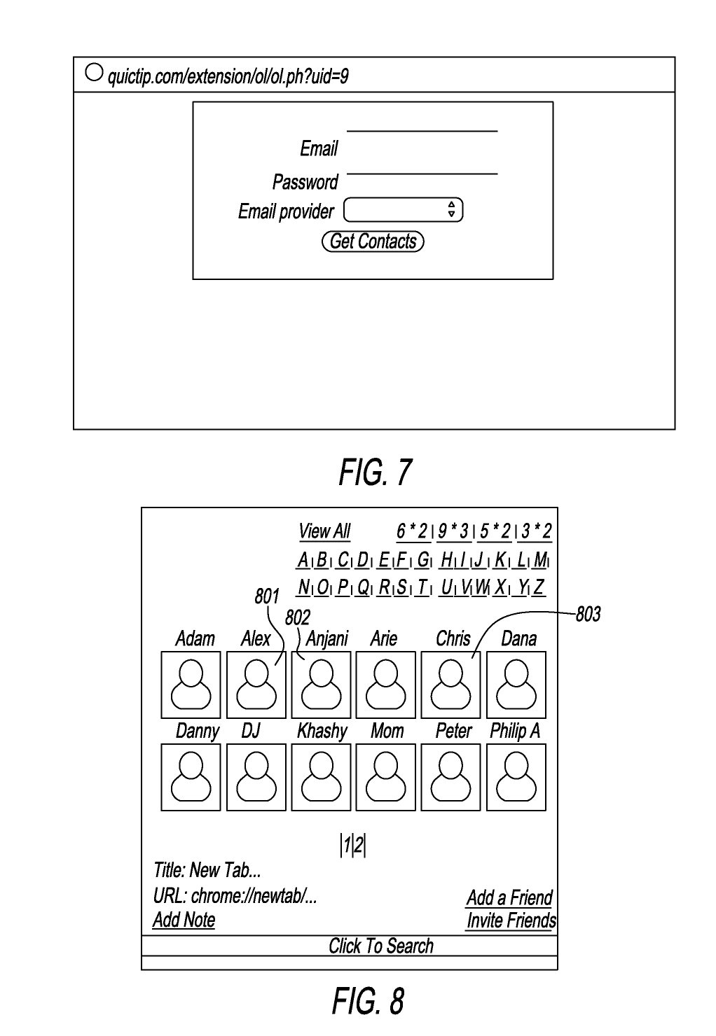

FIG. 7 shows an example embodiment of populating the contact database by importing the contacts from an email account from an internet email server, such as Gmail™, Hotmail™, Yahoo™ Mail etc.

FIG. 8 shows an embodiment that multiple email recipients 801, 802, 803 are selected for sending the web link with one sending action by clicking on their images.

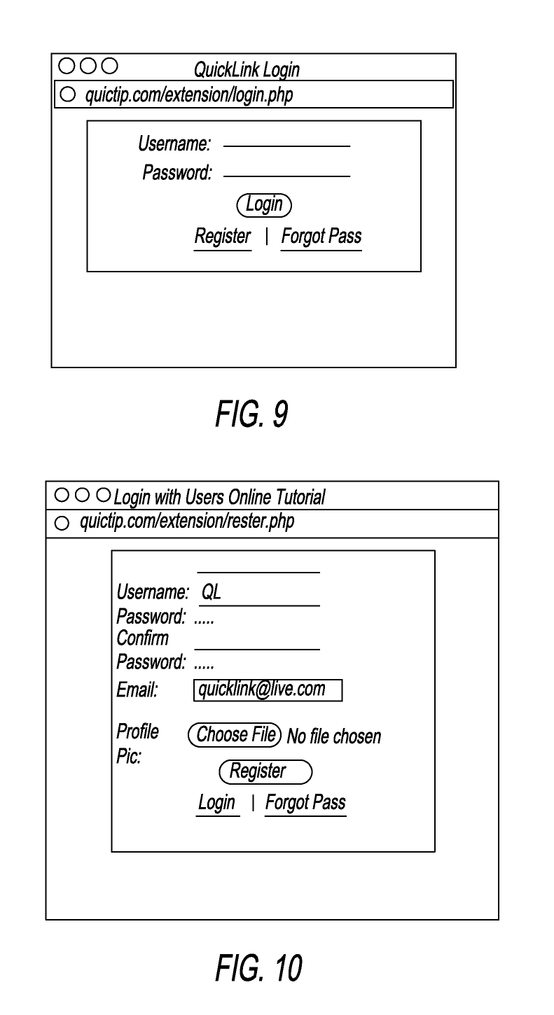

FIGS. 9 and 10 shows an embodiment that a user's Quicklink friend contact information and profiles are stored on a remote server connected through the internet. Users need register and use usernames and passwords to access the database.

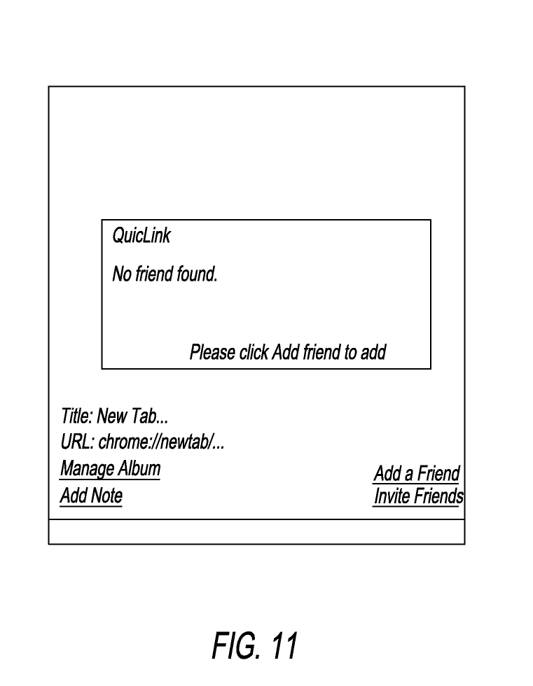

FIG. 11 shows an example pop-up window when the Quicklink friend contact database is not populated yet.

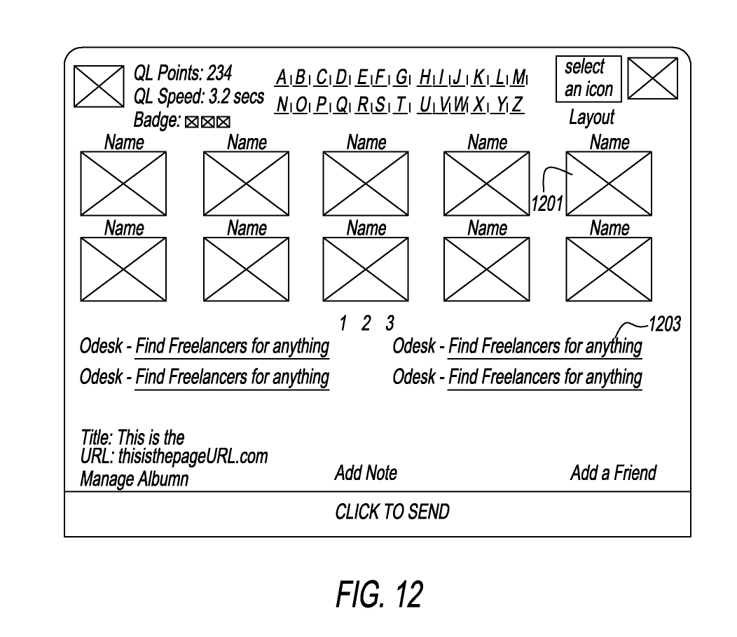

FIG. 12 shows an alternative pop-up graphic design, where friend images 1201 are not activated by clicking, but simply by placing cursor over for a period of time. Alternative targeted list of advertisements 1203 are listed at the bottom of the displays of image profiles which may include but is not limited to serving ads in extension pop-ups, a 3 click method with ads served in an email, and game mechanics for extensions where gaming points are obtained every time a quicklink is sent. Other buttons may also not be activated by clicking, but by having the cursor over for a few seconds. An example of such click less user interface may be found at http://www.dontclick.it

As will be recognized by those skilled in the art, the innovative concepts described in the present application can be modified and varied over a tremendous range of applications, and accordingly the scope of patented subject matter is not limited by any of the specific exemplary teachings given. It is intended to embrace all such alternatives, modifications and variations that fall within the spirit and broad scope of the appended claims.

Additional general background, which helps to show variations and implementations, may be found in the following US patent application publications, all of which are hereby incorporated by reference herein for all purposes: US 2002/0073149 A1, US 2006/0224997 A1, US 2009/0063953 A1.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A computing device for running an internet browser having a quicklink add on button for sending a web link to a friend, comprising:
a hardware device installed with a quicklink add-on software and an internet browser software; and
a display electronically communicating with said hardware device, wherein said quicklink add-on is shown as a button on the internet browser displayed on said display, and said quicklink add-on pops up a window when activated displaying a friend contact object which can be selected for sending a web internet address by placing a computer cursor over the contact object.

2. The computing device of claim 1, wherein said quicklink add-on button pops up a window that imports friend contact information from an internet mail server.

3. The computing device of claim 1, wherein said friend contact object includes images.

4. The computing device of claim 1, wherein said quicklink add-on button pops up a window that registers a user to a remote server.

5. The computing device of claim 1, wherein said quicklink add-on button pops up a window that displays a plurality of friend contact objects and a plurality of friend contact objects can be selected simultaneously for sending a web internet address.

6. The computing device of claim 1, wherein said quicklink add-on button pops up a window that adds a message to the web internet address.

7. The computing device of claim 1, wherein said quicklink add-on button pops up a window that enables the friend contact object be edited

8. The computing device of claim 1, wherein said quicklink add-on button is mouse-cursor activated.

9. The computing device of claim 1, wherein said quicklink add-on button pops up a window wherein at least one function is mouse cursor activated.
